(19) United States
(12) Patent Application Publication
(10) Pub. No.: US 2009/0234629 A1
(43) Pub. Date: Sep. 17, 2009

(54) Control and online real time monitoring of purity for fatty acid alkyl ester refinery

(75) Inventors: Orion Noah Polinsky, Bellingham, WA (US); Atul Sharad Deshmane, Bellingham, WA (US)

Correspondence Address: Orion Polinsky, 3012 Barkly Grove loop, Bellingham, WA, 98226, US

(73) Assignee: WHOLE ENERGY FUELS CORPORATION, Bellingham, WA (US)

(21) Appl. No.: 12/075,277

(22) Filed: Mar. 11, 2008

(51) Int. Cl. G06G 7/12

(52) U.S. Cl. 703/12

(57) ABSTRACT

The production of fatty acid alkyl esters in a refinery setting is broken into three sections which comprise of: the preprocessing high FFA feedstocks; the transesterification of feedstock into fatty acid alkyl esters and; the purification of the fatty acid alkyl esters. Within each of these sections of the refinery, a system of controls and an on-line, real time series of tests utilizing pH, conductivity, viscosity, near infra red spectroscopy, gas chromatography water content and flash point are utilized to tell a process controller when the product is acceptable to move to the next stage of processing.

### RELATED APPLICATIONS

This application claims the benefits of U.S. Provisional Patent Application No. 60/905,868 filed on 9 Mar. 2007 and U.S. Provisional Patent Application No. 60/905,881 filed on 9 Mar. 2007.

### FIELD OF THE INVENTION

The invention primarily relates to systems and methods of controls and real time monitory systems for purity of fatty acid alkyl esters for manufacturing and processing fuels and, more particularly, fatty acid alkyl esters.

### BACKGROUND OF THE INVENTION

When manufacturing fatty acid alkyl esters, analytical testing is required to verify that the properties of the fatty acid alkyl esters are within defined specifications. The refining operation, in some approaches, may be performed batch wise in a tank or by continuous processes. Typical analytical tests, such as gas chromatography, kinematic viscosity as per ASTM D-445 or flash point—closed cup ASTM D93, are performed on samples in a laboratory. Depending on laboratory operations and conditions, tests may require more than an hour for completion, and the blending process is typically suspended until satisfactory results are obtained. The delays may be extended if the results are unsatisfactory.

Systems for in-situ monitoring of lubricating fluids are known. One such system is disclosed in U.S. Pat. No. 6,278,281 entitled “Fluid Control Monitor” issued to Bauer, et al. This patent describes a technique employing AC electro-impedance spectroscopy (referred to hereinafter as impedance spectroscopy or “IS”), and is implemented by means of probe electrodes placed in contact with the fluid to be tested. The method of operation includes making IS measurements at a first frequency that is less than 1 Hz and a second frequency that is greater than 1 Hz, comparing the two IS measurements, and declaring a “pass” or “fail” condition based on a previously determined empirical relationship.

However, this prior art is for a lubricating fluid monitoring system utilizing only a single characteristic. There is also no use of an AC electro-impedance spectroscopy system in the fatty acid alkyl ester refinery.

There are also process control systems which collect data and can predict how to optimize the operation. One such system is disclosed in U.S. Pat. No. 6,298,454 entitled “Diagnostics in a Process Control System,” issued to Schleiss, et al. This system is known to run control optimizers, such as real time optimizers, within a plant to optimize the control activities of the process plant. Such optimizers typically use complex models of the plant to predict how inputs may be changed to optimize operation of the plant with respect to some desired optimization variable such as, for example, profit. In many cases, however, these optimizers are provided by outside service organizations and, thus, are not directly accessible to other areas of the plant.

U.S. Pat. No. 7,206,646 entitled “Method and apparatus for performing a function in a plant using process performance monitoring with process equipment monitoring and control” issued to Nixon, et al. provides a very broad controls patent. It is a process control system that uses a data collection and distribution system and an asset utilization suite to collect data or information pertaining to the assets of a process plant from various sources or functional areas of the plant. Although this patent covers many areas for which a process controller may be utilized it makes no mention of its use in a fatty acid alkyl ester refinery, nor does it specifically utilize the instrumentation devices used in the processing of fatty acid alkyl esters.

U.S. patent No. 20050240289 entitled “Methods and systems for monitoring machinery” issued to Hoyte, Scott Mordin; et al. provides a real time controls system patent. Their method includes receiving, in real-time, from a variety of equipment combinations, a plurality of measured process parameters, determining at least one derived quantity from the plurality of measured process parameters, and recommending a change to an equipment operation based on the measured process parameters and the derived quantities. This patent is similar in idea to the disclosed patent, but it is specific to monitoring pieces of machinery as opposed to a chemical process.

There are many designs of fatty acid alkyl ester refineries. One such system is disclosed in U.S. Pat. No. 6,979,426 entitled “Biodiesel production unit” issue to Teall, et al. In their patent three aspects are disclosed. The first aspect is a modular production unit incorporated onto a single platform or into a housing for ease of relocatability. In a second aspect, the modular production unit is combined with additional fixed and/or relocatable components to provide a biodiesel processing plant. In a third aspect, a raw materials processing system and method includes a roller barrel adapted for recovery, transportation, and introduction of recycled oil feedstock into a biodiesel manufacturing process.

Another design for a fatty acid alkyl ester refinery is disclosed in U.S. Pat. No. 5,713,965 entitled “Production of biodiesel, lubricants and fuel and lubricant additives” issued to Foglia, et al. This design utilizes lipases to transesterify triglyceride-containing substances and to esterify free fatty acids to alkyl esters using short chain alcohols. The alkyl esters are useful as alternatives or additives to automotive fuels and lubricants. The method is particularly advantageous because it utilizes inexpensive feedstocks such as animal fats, vegetable oils, rendered fats and restaurant grease as substrates.

However both of these prior arts do not discuss a controls system or an on-line real time quality system. No mention is made of a process controller or automated valves or load cells. These patents are for an arrangement of processing equipment, or a chemical processing pathway rather than a controls system that can be modified to work with a fatty acid alkyl ester refinery.

### SUMMARY OF THE INVENTION

In order to make these controls, it is necessary to build a control system hardware and software so that a series of process measurements are recorded in real-time. Process measurements include measurements that help determine completeness of reaction (pH, temperature, viscosity, specific gravity, infra-red, optical, conductivity, chromatographic) and measurements that help determine the physical state of the material being process (temperature and load). These process measurements are then used to trigger pumps, valves that manage the reaction and purification processes.

The control system is built on three types of controls. The first type is for injecting acids and bases utilizing a pH controlled system in combination with load cells and flow rates measurements. The second type is for real time monitoring devices which determine the time a reaction or purifying process lasts. The third type is utilized as a check point after each process to determine if the product is sent to the next processing step. A three way valve system is in place after the checkpoint which gives a pass, fail or reject decision. A yes triggers a valve to go on to the next processing stage, a no triggers a valve to go back to the previous processing stage and a fail triggers a valve to get sent to a holding tank for further analysis.

### BRIEF DESCRIPTION OF THE DRAWINGS

FIG. 1 describes the layout of the controls in a typical biodiesel production facility.

### DETAILED DESCRIPTION OF THE PREFERRED EMBODIMENTS

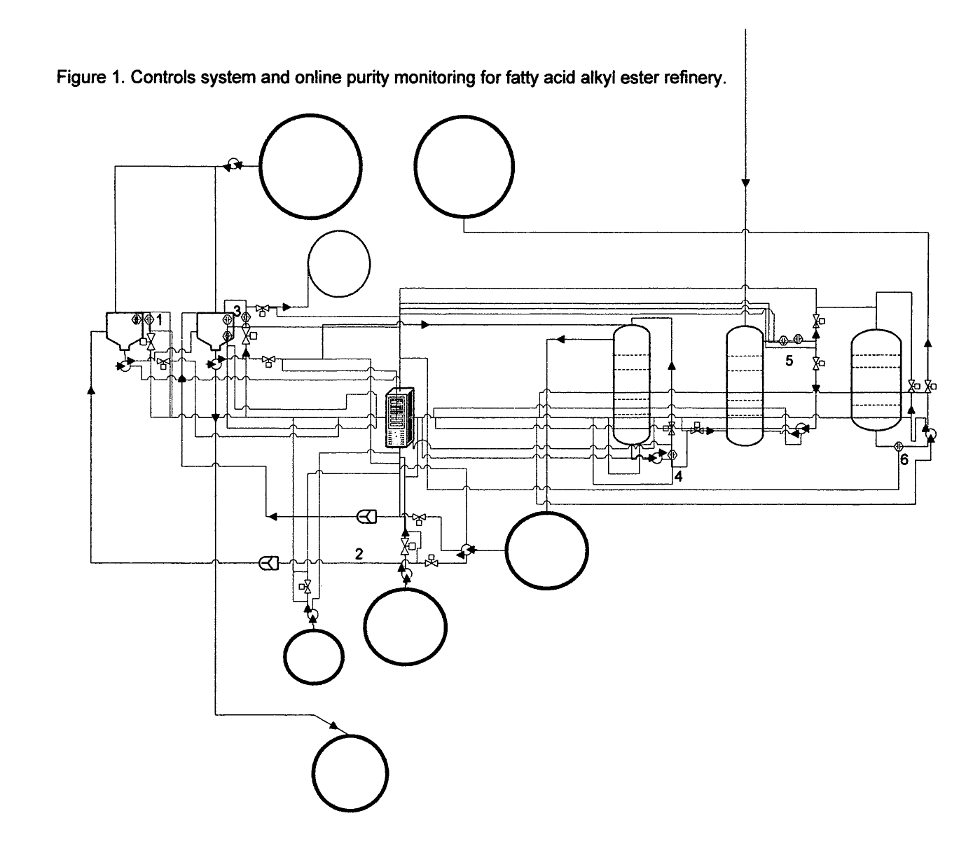

Reference will now be made to FIG. 1, which provides a schematic representation of one preferred controls and online real time monitoring for a fatty acid alkyl ester refinery. The process control system, used in the fatty acid alkyl ester refinery typically includes one or more centralized or decentralized process controllers communicatively coupled to at least one host or operator workstation and to many process control and instrumentation devices, such as pH meters, via analog, digital or combined analog/digital buses. Field devices, which are valves, valve positioners, switches, transmitters, and sensors (e.g., temperature, pressure and flow rate sensors), perform functions within the process such as opening or closing valves and measuring process parameters. The process controller receives signals indicative of process measurements or process variables made by or associated with the field devices and/or other information pertaining to the field devices, uses this information to implement a control routine and then generates control signals which are sent over one or more of the buses to the field devices to control the operation of the process. Information from the field devices and the controller is typically made available to one or more applications executed by an operator workstation to enable an operator to perform desired functions with respect to the process, such as viewing the current state of the process, modifying the operation of the process, etc.

The system of controls for the fatty acid alkyl ester refinery is split into three sections of the plant and three types of control systems. The three sections of the refinery are the preprocessing of the oil; the conversion of oil into fatty acid alkyl esters; and the purification portion of the refinery. Within each of these sections of the fatty acid alkyl ester refinery there are three types of controls used.

The first type is for injecting acids and bases utilizing a pH controlled system in combination with load cells and flow rates measurements. The second type is for real time monitoring devices which determine the time a reaction or purifying process lasts. The third type is utilized as a check point after each process to determine if the product is sent to the next processing step. A three way valve system is in place after the checkpoint which gives a pass, fail or reject decision. A yes triggers a valve to go on to the next processing stage, a no triggers a valve to go back to the previous processing stage and a fail triggers a valve to send material to a holding tank for further analysis.

The first stage of the fatty acid alkyl ester refinery is the preprocessing stage. Any oil or fat may be processed into fatty acid alkyl ester as long as the free fatty acid percentage is below 3%. Many oil feedstocks such as animal fats, yellow grease, brown grease and unrefined virgin oils contain free fatty acid percentages exceeding 3%. The free fatty acids may be processed into fatty acid alkyl esters by the process of esterification where an acidic catalyst such as sulfuric acid or a solid acid catalyst is used with an alcohol. This process directly esterifies the fatty acids to fatty acid alkyl esters and lowers the total percentage of the fatty acids in the triglycerides to below 2% so that the oil can move on to the second stage of the refinery where the triglycerides are processed with a base catalyst such as sodium or potassium hydroxide.

This is a known process but the difficulty is in calculating the amounts of the acid catalyst and the alcohol to push the reaction into a high conversion. Within this stage of the refinery the control system would consist of load cells on the processing tank, the storage tank for the acid catalyst and the storage tank for a low molecular weight alcohol. Each of the tanks would have automated valves and flow meters which are capable of sending and receiving signals from a process controller.

The processing tank would be outfitted with pH meters and viscosity meters (1) and these would send signals to the process controller. Based on the weight of the oil to be processed and the pH the the process controller will use an empirical model to calculate the amount of acid catalyst and low molecular weight alcohol to mix with the oil to lower the free fatty acid percentage below two percent. The time for the reaction will be controlled by the viscosity reading and the pH readings; the point at which it is complete is based on an undisclosed empirical model that identifies the completion point of the reaction based on the two data points of viscosity and pH.

When the reaction is complete the process controller sends a signal to the automated valves to stop circulating the product and to send it to the next reaction vessel were the transesterification reaction is undergone. This is the second stage of the fatty acid alkyl ester refinery. Within this section there are load cells on the transesterification reactor, the catalyst tank (in this case it is a sodium methylate or a potassium methylate), and the methanol tank. The valves on each of the tanks are automated and there are flow meters set on each of the tanks which are integrated into the process controller. Based on the data provided from the previous processing stage, the amounts of catalyst and methanol are determined and are pumped (2) through a static mixer as they are mixed with the oil feedstock in the transesterification reactor.

Within the transesterification reactor system, there is an inline viscosity meter and a Near-Infrared (NIR) Spectroscopy with a fiber optics probe (3) inserted into the reactor. The NIR spectrometer has been shown to distinguish purity of alkyl esters between the spectra range of 4300-7300 cm−1. It can distinguish triglycerides, triglycerides that are partially reacted into fatty acid alkyl esters and fully reacted fatty acid alkyl esters based on the spectra range (Knothe 1999).

The viscosity of triglycerides, (which are the feedstocks for alkyl esters) and alkyl esters are one order of magnitude different. The completeness of the reaction can thereby be determined by the viscosity of the product as it is mixed by utilizing a pump style mixing system that re-circulates the reacting products in the transesterification system through a recirculation pipe with an inline viscosity meter installed.

The reaction will continue to mix until both the viscosity and the reading from the NIR spectrometer corroborate that the reaction is complete. At this time a small amount of the product is fed to an in-line gas chromatograph (GC) which performs the ASTM 6584 analysis which is for the determination of free and total glyerides in a 100% biodiesel sample. If the GC determines that the monglyceride percentage is below 0.8%, the diglyceride percentage is below 0.2% and triglycerides percentage is below 0.2% then the process controller will close the valve for the recirculation line from the pump and open the valve to the purification portion of the refinery. If the GC determines that the monglyceride percentage is higher than 0.8%, the diglyceride percentage is higher than 0.2%, and/or the triglycerides percentage is higher than 0.2% then the process controller will reprocess the oil and determine the amounts of catalyst and methanol to add to the oil based on the percentages of monoglycerides, diglycerides and triglycerides. The reaction will go again until the viscosity meter and NIR spectrometer indicated that the reaction is done and again a small amount of the product is fed to an in-line gas chromatograph (GC) which performs the ASTM 6584 analysis which is for the determination of free and total glyerides in a 100% biodiesel sample. If the GC determines that the monglyceride percentage is below 0.8%, the diglyceride percentage is below 0.2%, and triglycerides percentage is below 0.2% then the process controller will close the valve for the recirculation line from the pump and open the valve to the purification portion of the refinery. If the product fails again the process controller will open a third valve and pump the product to a storage tank for operators to perform more testing to determine why the product is not completely reacting.

The third stage of the fatty acid alkyl ester refinery is the purification stage. This stage consists of three parts. The first portion is the methanol recovery, the second stage is the wash column or a packed column with wash substitute such as amberlite, perlite, or magnesium silicate, the last portion is a drying portion to remove any water.

The methanol recovery portion is controlled by temperature and vacuum. After the biodiesel has passed through the methanol recovery portion an inline NIR probe (4) determines the alcohol content of the fatty acid alkyl ester. If the alcohol percentage is below 0.1% then this implies that the alcohol is sufficiently removed to meet the flash point minimum of 130 degrees C. This signals the process controller to open the valve and signals the pump to pass the fatty acid alkyl ester to the wash or wash substitute system. If the NIR probe determines the alcohol percentage is above 0.1% then the process controller opens the valve and signals the pump to pump the fatty acid alkyl ester back through the methanol recovery system. The temperature is checked to insure it is above 90 degrees C. If it is not above 90 degrees C. then the process controller signals the methanol recovery system to increase the heat. After the fatty acid alkyl ester has met the minimum requirements for alcohol content, it is moved to the wash system.

Within the wash system or a wash system substitute free glycerin and salts are removed. The method in which the process controller can control this system is by control of the pump speed to change retention time through this purification system. The instruments which measure the effectiveness of the wash column or wash column substitute are a pH probe and a conductivity probe (5).

The pH of alkyl ester is neutral in its pure form. If too much catalyst is added alkyl ester becomes alkaline, and if too much acid is used in the wash alkyl ester becomes acidic. The purity of the alkyl ester can thereby be determined in terms of pH by continuously monitoring the alkyl esters inline after it has passed through the purification system of the alkyl ester processing facility.

Conductivity meters are known to show the presence of salts such as Na, K, Ca, or Mg and some weak and strong acids, such as but not limited to free fatty acids, sulfuric acid, citric acid or hydrochloric acid. Fatty acid alkyl esters have a minute signal in a pure form. The presence of salts left over from the catalyst or acids or bases will provide a strong signal. The purity of the alkyl ester in terms of salts and acids can thereby be determined by continuously monitoring the alkyl ester after it has passed through the purification system of the alkyl ester processing facility.

The method by which the process controller makes a decision on whether to allow the fatty acid alkyl ester to move on to the final step in the purification system is based upon an empirical model which utilizes the information transferred from the pH probe and the conductivity probe. If the fatty acid alkyl ester is acceptable then the process controller opens the valve to the final stage of the purification system. If the fatty acid alkyl ester is not acceptable the process controller opens a valve for the fatty acid alkyl ester to pass through the wash system or wash system substitute. If the product passes through and it again is unacceptable, the process controller notifies the operator to check the wash water or the ion exchange media to see if it is saturated. The process controller will shut off pumps directing product to the wash system or wash system substitute until the plant operator manually overrides the process controller.

The final step of the purification system is the drying system. This can be a centrifuge or a drying column. In either case there is an inline water sensor (6) set after the drying system. If water is detected the process controller sends the fatty acid alkyl ester back through the drying system if there is not water detected the process controller opens the valve to send it to the finished product tank.

In order to use these controls, it is necessary to have a team including a plant operator capable of supervising the operation of a plant. These controls must be continually adapted in the presence of new feedstocks and variations of existing feedstocks. The design of the production plant must include control hardware that is flexible, programmable and responsive in real-time. The operations team must have sufficient understanding of biodiesel production so as to enable them to understand and implement a process of ongoing improvement. The procurement function of a biodiesel production company should understand the relative merits of feedstocks so as to optimize the financial benefit of feedstock robustness because of the impact of feedstock quality on yield and production cost.

### EXAMPLE

A sample of yellow grease was run through a pilot plant as described in FIG. 1. The yellow grease measured 8% free fatty acid (ffa). The oil was pumped into the esterification reactor and the process controller engaged the circulating pump and opened the valves for steam. The pH sensor and the viscosity readings as well as the weight of oil in the tank, temperature and the flow rate were displayed in real time through the process controller. Calculations of the amounts of acid and methanol were preformed from the process controller and the pumps from the acid tank and the methanol tank were turned on and pumped calculated weights of each from the load cells on the tanks. The acid and methanol mixture was mixed into the circulating pump on the esterification reactor. The reaction continued until the process controller received the appropriate signals from the pH meter and the viscosity meter at which point it closed the valve on the recirculating line and opened the valve to pump the processed oil to the transesterification reactor.

Within the transesterification reactor the process controller was receiving signals from the viscosity meter, the NIR probe, the temperature probe and the load cell. The temperature was correct for transesterification so the process controller did not open the steam valves. The process controller calculated the amounts of methylate and methanol to add then opened the valves from the methylate tank and the methanol tank and engaged the pumps until the calculated amounts were added. The mixture of catalyst and methanol were mixed in the transesterification reactor and the reaction continued until the process controller received the appropriate readings from the viscosity meter and the NIR probe. A sample was then drawn into the inline GC and tested for monoglycerides, diglycerides and triglycerides. The GC showed 0.7% for monoglycerides, 0.14% for diglycerides and 0.01% for triglycerides. The values fell within the specifications for glycerin and the fatty acid alkyl esters where allowed to pass on to the purification portion of the refinery.

The process controller engaged the pump to move the fatty acid alkyl ester to the methanol recovery column. After the fuel was demethanized a small sample was passed through a flash point tester. The flash point was 135 degrees C. and the process controller opened the valve to allow it to go into the wash column. The process controller set the pump speed to 15 gpm and monitored the pH and conductivity of the fuel as it exited the washing column. The fuel that passed through was acceptable and the fatty acid alkyl ester was pumped into the drying column. The process controller increased the temperature to 100 degrees C. and the fatty acid alkyl ester was pumped through the column. At the end of the column a water sensor continuously monitored the fatty acid alkyl ester flowing to the final storage tank.

What is claimed is:

1. A controls and real time quality system that automates the production of fatty acid alkyl esters and insures that the fatty acid alkyl ester is of a high quality.

2. The controls system of claim 1 is broken into three sections of a fatty acid alkyl ester refinery. The first portion is for preprocessing of the triglyceride feedstock. The second section is the processing of triglycerides into fatty acid alkyl esters. The third portion of the refinery is the purification of the fatty acid alkyl esters.

2 a. The controls system of claim 2 can be used independently in any of the sections of the alkyl ester refinery or in conjunction with two of the sections or all three sections or any subsections of the refinery.

3. The control system of claim 2 is further classified into three types of controls. The first type is for injecting acids and bases utilizing a pH controlled system in combination with load cells and flow rates measurements. The second type is for real time monitoring devices which determine the time a reaction or purifying process lasts. The third type is utilized as a check point after each process to determine if the product is sent to the next processing step.

4. The controls system is run by a process controller, which takes the information from the monitoring systems and the load cells and flow meters to make decisions on where the fuel should be sent in the processing system utilizing a pass, fail, or reject decision.
